(19) United States
(12) Patent Application Publication
(10) Pub. No.: US 2020/0398419 A1
(43) Pub. Date: Dec. 24, 2020

(54) CHAINSAW CHAIN HOLDER

(71) Applicant: Daniel J. Hanood, Oak Ridge, NC (US)

(72) Inventor: Daniel J. Hanood, Oak Ridge, NC (US)

(21) Appl. No.: 16/907,758

(22) Filed: Jun. 22, 2020

Related U.S. Application Data
(60) Provisional application No. 62/865,711, filed on Jun. 24, 2019.

(51) Int. Cl. B25H 3/04; F16B 2/04

(52) U.S. Cl. CPC B25H 3/04; B27B 33/14; F16B 2/04

(57) ABSTRACT

A holder or carrier for continuously looped articles, e.g., chainsaw chains, is provided which prevents kinking and holds such articles in a secure, extended condition.

### CROSS-RELATION TO RELATED PATENT APPLICATIONS

This application claims benefit of U.S. Provisional Patent Application No. 62/865,711, filed Jun. 24, 2019, the contents of which are fully incorporated herein by reference.

### BACKGROUND OF THE INVENTION

The invention relates generally to an apparatus for transport and storage of continuously looped articles prone to tangling and damage when transported to stored loosely. In particular, the invention relates to an effectively means of transporting and storing chainsaw chains.

Chainsaw chains are continuous loop chains that act as a blade when installed on the guide bar of a chainsaw. Each link comprises a blade that is sufficiently sharp to cause injuries to a person when handling the chain without benefit of a glove. Further, when the chainsaw chain is stored or carried in a loose condition, the chain is prone to fold back on itself and become kinked. Before re-installation on the chainsaw guide bar, the chain must be straightened and unkinked. This is time consuming and dangerous due to the sharp links of the chain.

A need exists for an apparatus that would allow transport and storage of chainsaw chains such that the chain is held in an extended looped configuration such that it does not tangle and can be removed and installed easily without extra handling.

### SUMMARY OF THE INVENTION

In one aspect, the invention relates to a holder for looped articles, comprising an upper member, a lower member, at least two holding pegs, and a shock absorber or spring, wherein at least one of the at least two holding pegs is disposed on the upper member and at least one of the at least two holding pegs is disposed on the lower member, and wherein the shock absorber is connected at one end to the upper member and to the lower member at the opposite end, and is configured to urge the upper member and lower member away from one another.

In one embodiment, the upper member and the lower member are hollow, and the upper member is slidably inserted into the lower member in a coaxial manner. In one embodiment, the shock absorber or spring is positioned within the hollow upper and lower members in a coaxial position.

In another embodiment, the holder comprises an upper cross member attached to an upper end of the upper member a lower cross member attached to the lower end of the lower member, wherein both cross members are perpendicular to a long axis of the upper and lower members and are attached to the upper and lower members at a point substantially central to a long axis of the upper and lower cross members.

In one embodiment, the holder comprises at least two upper holding pegs attached to the upper member and at least two lower holding pegs attached to the lower member. In one embodiment, the at least two upper holding pegs are attached to opposite sides of the upper member at the same position relative to a long axis of the upper member, and wherein the at least two lower holding pegs are attached to opposite sides of the lower member at the same position relative to a long axis of the lower member. In one embodiment, the holding pegs are attached parallel to the upper and lower cross members.

In some embodiments, the at least one set of two holding pegs are provided by a single peg member that extends through the upper member or extends through the lower member to provide holding pegs on each side of the upper member or lower member. In one embodiment, the holding pegs are retained by caps. In one embodiment, the caps comprise rubber or polymer.

In some embodiments, the upper member comprises multiple holding peg holes for alternative placement of holding pegs.

In some embodiments, the lower member comprises multiple holding peg holes for alternative placement of holding pegs.

In some embodiments, the upper member and lower member comprise holding pegs on four sides of the upper member and lower member. In one embodiment, the upper cross member and lower cross member are absent and an upper and lower cross plate are attached to the ends of the upper member and lower member, wherein the plane of each cross plate is perpendicular to the long axis of the upper member and lower member.

In one embodiment, the holder comprises a spring.

In one aspect, the invention relates to a holder for looped articles comprising an upper member, a lower member, an upper cross member, a lower cross member, at least two holding pegs, and a shock absorber, wherein at least one of the at least two holding pegs is disposed on the upper member and at least one of the at least two holding pegs is disposed on the lower member, wherein the shock absorber is connected at one end to the upper member and to the lower member at the opposite end, and is configured to urge the upper member and lower member away from one another, and wherein the upper cross member is connected to the upper end of the upper member and the lower cross member is connected to the lower member, each cross member being substantially perpendicular to the long axis of the upper and lower members.

In one aspect, the invention relates to a holder for looped articles, the holder comprising an upper member, a lower member, at least two holding pegs, and at least one shock absorber or spring, wherein at least one of the at least two holding pegs is disposed on the upper member and at least one of the at least two holding pegs is disposed on the lower member, and wherein the at least one shock absorber or spring is connected at one end to the exterior of the upper member and to the exterior of the lower member at the opposite end, and is configured to urge the upper member and lower member away from one another.

In one embodiment, the holder comprises at least one shock absorber. In one embodiment, the holder comprises at least two shock absorbers. In one embodiment, the at least two shock absorbers are connected to the upper member and the lower member on opposite sides of the holder.

### BRIEF DESCRIPTION OF THE DRAWINGS

A more particular description will be rendered by reference to specific embodiments thereof that are illustrated in the appended drawings. Understanding that these drawings depict only typical embodiments thereof and are not therefore to be considered to be limiting of its scope, exemplary embodiments will be described and explained with additional specificity and detail through the use of the accompanying drawings in which:

FIG. 1 is a front orthogonal view of one example of the invention.

FIGS. 2A and 2B are front orthogonal views, detailed with cut away, showing an example of the invention having a shock absorber situated internally.

FIG. 3 is a front orthogonal view of an example of the invention having multiple holding pegs for holding chains of various length under appropriate tension.

FIG. 4 is a side orthogonal view of one example of the invention as shown in a front view of FIG. 3.

FIG. 5 is a partial front orthogonal view of one end of one example of the invention having a tab and hole to facilitate hanging of securing of the invention during storage or transport.

FIG. 6 is a front orthogonal view of an alternative biasing means for urging each end of one example of the invention away from each other, comprising a spring.

FIG. 7 is a three-quarter perspective view of one example of the invention.

FIG. 8 is a side orthogonal view of one example of the invention, as in FIG. 4, showing shock absorbers attached to the exterior of the upper member and the lower member, according to one embodiment.

Various features, aspects, and advantages of the embodiments will become more apparent from the following detailed description, along with the accompanying figures in which like numerals represent like components throughout the figures and text. The various described features are not necessarily drawn to scale but are drawn to emphasize specific features relevant to some embodiments.

The headings used herein are for organizational purposes only and are not meant to limit the scope of the description or the claims. To facilitate understanding, reference numerals have been used, where possible, to designate like elements common to the figures.

### DETAILED DESCRIPTION

The present invention provides a device which allows chainsaw chains or other closed loop articles to be transported or stored in manner which prevents entanglement and kinking. This provides a benefit to the user by saving time and, for use with chainsaw chains, prevents the likelihood of injury by attempting to straighten or unkink the chain prior to installation on a chainsaw bar.

The invention provides benefits in an uncomplicated way and allows for easy access to the stored articles, e.g., chainsaw chains.

Reference will now be made in detail to various embodiments. Each example is provided by way of explanation and is not meant as a limitation and does not constitute a definition of all possible embodiments.

For purposes of illustrating features of the embodiments, examples will now be introduced and referenced throughout the disclosure. Those skilled in the art will recognize that these examples are illustrative and not limiting and are provided purely for explanatory purposes.

The present disclosure, in various embodiments, configurations and aspects, includes components, methods, processes, systems and/or apparatus substantially developed as depicted and described herein, including various embodiments, sub-combinations, and subsets thereof. Those of skill in the art will understand how to make and use the present disclosure after understanding the present disclosure. The present disclosure, in various embodiments, configurations and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The phrases “at least one,” “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

In this specification and the claims that follow, reference will be made to a number of terms that have the following meanings. The terms “a” (or “an”) and “the” refer to one or more of that entity, thereby including plural referents unless the context clearly dictates otherwise. As such, the terms “a” (or “an”), “one or more” and “at least one” can be used interchangeably herein. Furthermore, references to “one embodiment,” “some embodiments,” “an embodiment” and the like are not intended to be interpreted as excluding the existence of additional embodiments that also incorporate the recited features. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Terms such as “first,” “second,” “upper,” “lower,” etc. are used to identify one element from another, and unless otherwise specified are not meant to refer to a particular order or number of elements.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

As used in the claims, the word “comprises” and its grammatical variants logically also subtend and include phrases of varying and differing extent such as for example, but not limited thereto, “consisting essentially of” and “consisting of.” Where necessary, ranges have been supplied, and those ranges are inclusive of all sub-ranges therebetween. It is to be expected that variations in these ranges will suggest themselves to a practitioner having ordinary skill in the art and, where not already dedicated to the public, the appended claims should cover those variations.

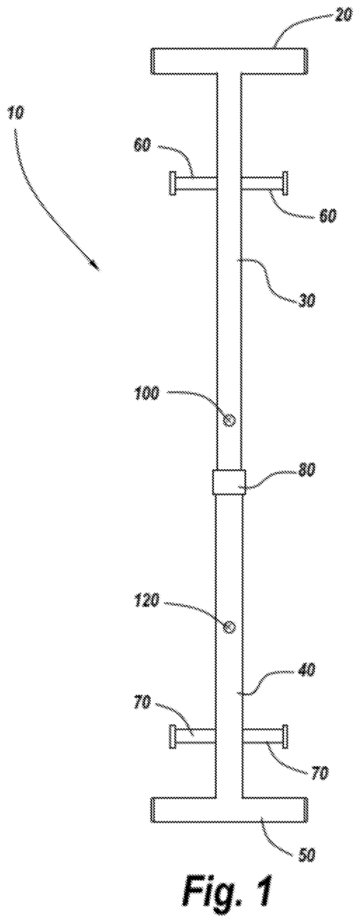

Referring now to the drawings illustrating particular embodiments of the invention, in FIG. 1, a front orthogonal view of an example of a chainsaw chain holder 10 showing upper member 30 inserted into lower member 40. Each of upper member 30 and lower member 40 may be connected to a perpendicular upper cross member 20 and/or lower cross member 50, respectively. Upper cross member 20 and/or lower cross member 50 can stabilize chain holder 10 during compression allowing chains to be looped around one of upper holding pegs 60 and one of lower holding pegs 70 (a single chain or looped article looped around pegs on same side of holder 10). When the pressure, applied manually, is released, an internal mechanism urges upper member 30 away from lower member 40 such that upper holding pegs 60 are urged away from lower pegs 70, and the chain(s) or other looped article(s) are held extended under tension. The internal mechanism can be attached at the upper end via upper fastener 100 which is inserted through upper member 30, and lower fastener 120 inserted through lower member 40. Further, in this example, lower member 40 is capped with collar 80, which closely fits the diameter of upper member 30 and facilitates the fit and sliding of upper member 30 within lower member 40.

In some embodiments, collar 80 is formed from polymer material. This facilitates smooth sliding between upper member 30 and lower member 40 and reduces frictional wearing and noise when the chain holder 10 is compressed and released during use. Holding pegs 60 and 70 can also be coated with polymer or rubber. Holding pegs 60 and 70 generally have an enlarged diameter cap, sufficiently larger that the main peg diameter to aid in retention of the looped articles, e.g., chainsaw chains. Upper and lower cross members 20 and 50 can also have polymer caps to reduce abrasion against other surfaces, e.g., during transport, and to protect the ends of cross members 20 and 50.

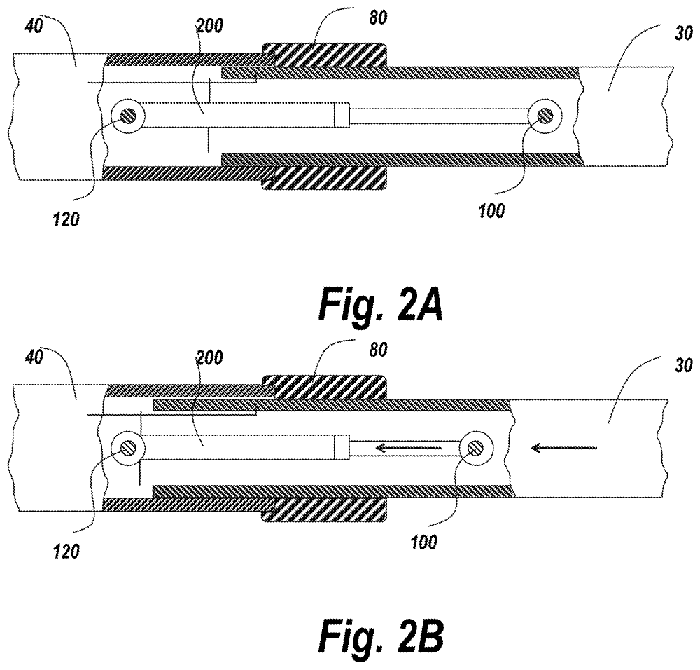

In FIGS. 2A and 2B cut-away front orthogonal views are shown. Upper member 30 is shown to the right and lower member 40 is shown to the left. The cut-away view exposes the internal, hollow space inside each member to the point of attachment of shock absorber 200 to fastener 100 in upper member 30 and fastener 120 in lower member 40. Collar 80 is also shown. When upper member 30 is pushed into lower member 40, shock absorber 200 is compressed and exerts a biasing force against each fastener (100 and 120) to urge upper member 30 and lower member 40 away from one another (See FIG. 2B). As biasing means, spring shock 400 (see FIG. 6) may be used instead of shock absorber 200, although shock absorber 200 provides smoother action and creates less noise in use than spring shock 400.

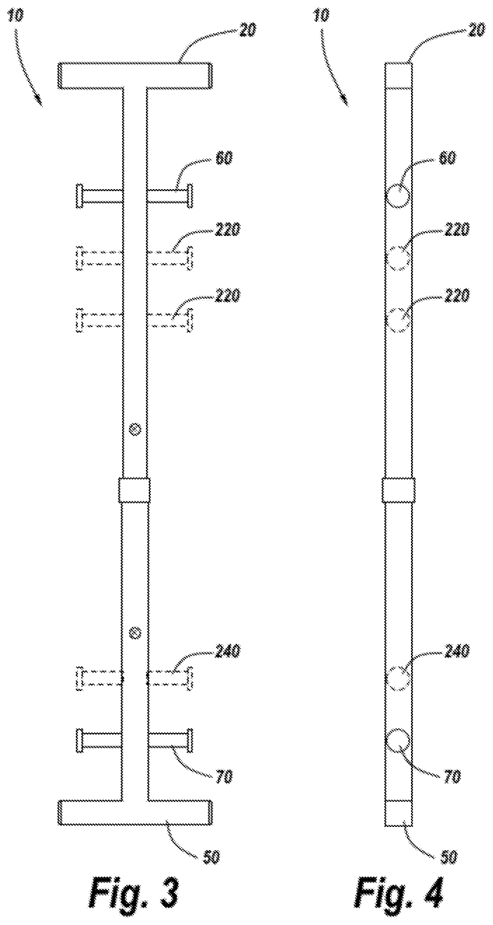

FIG. 3 illustrates an alternative embodiment of chain holder 10 having multiple points of attachment for chains on each side of chain holder 10. Additional holding pegs holes are provided for movement of holding pegs 60 and 70 are provided as positions 220 and 240. In addition, for properly placed additional holding pegs, e.g., in lengths matching standard chainsaw chain lengths, multiple pegs can be installed for use with multiple chain lengths simultaneously. FIG. 4 shows a side orthogonal view of holder 10, showing holding peg holds for multiple holding peg placement.

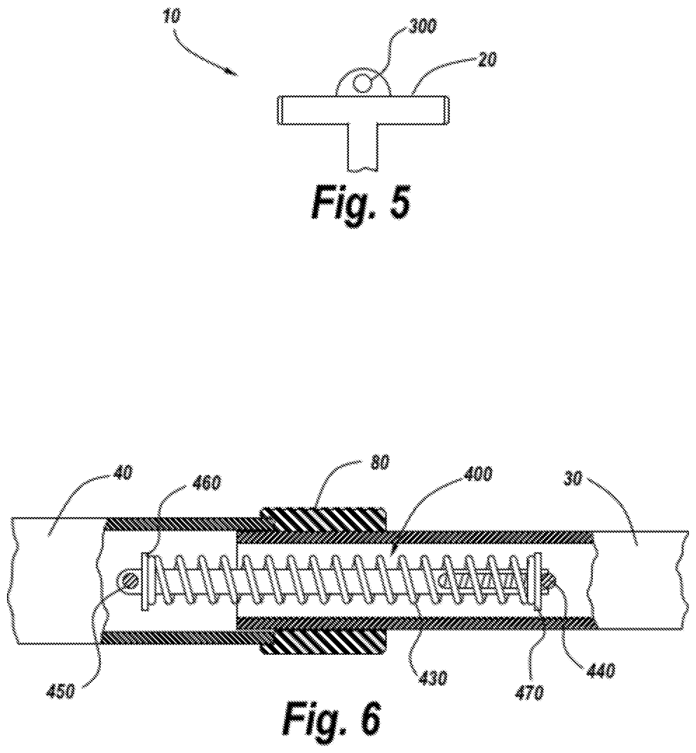

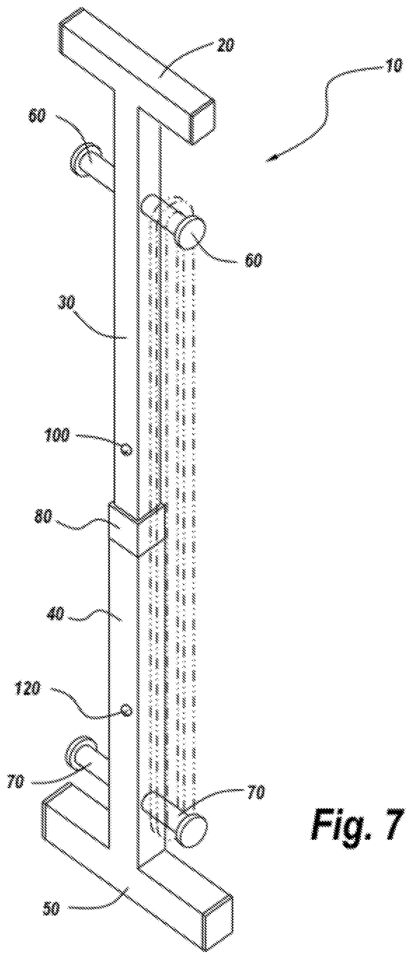

FIG. 5 shows one embodiment of holder 10 having a means for hanging or attaching holder 10 to a base, for transport or storage.

FIG. 6 shows one alternative biasing means for urging upper member 30 and lower member 40 apart, that is, spring shock 400, having a first slide member 410 disposed in close parallel arrangement to second slide member 420, where end tabs 460 and 470 hold spring 430 captive and stretch spring 430 as upper member 30 is pushed into lower member 40. Spring 430 then urges upper member 30 out of lower member 40 to apply tension to any looped articles held on holder 10, i.e., on holding pegs 60 and 70.

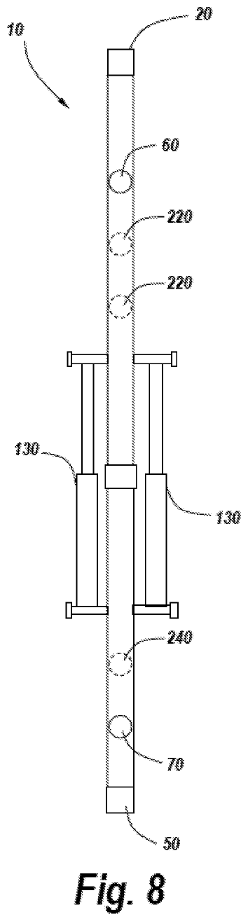

FIG. 8 shows an alternative embodiment wherein exterior shock absorbers 130 are attached to the exterior of the upper member 30 and the lower member 40 on opposite sides of the chain holder 10. In the embodiment illustrated in FIG. 8, the shock absorbers 130 are attached the sides of the chain holder 10 orthogonal to the holding pegs 60 and 70. In some embodiments, the shock absorbers 130 may be attached on the same side of the chain holder 10 as the holding pegs 60 and 70.

The holder can be constructed of any suitable rigid material, preferably aluminum, although other materials such as steel can be used.

The foregoing discussion of the present disclosure has been presented for purposes of illustration and description. The foregoing is not intended to limit the present disclosure to the form or forms disclosed herein. In the foregoing Detailed Description for example, various features of the present disclosure are grouped together in one or more embodiments, configurations, or aspects for the purpose of streamlining the disclosure. The features of the embodiments, configurations, or aspects of the present disclosure may be combined in alternate embodiments, configurations, or aspects other than those discussed above. This method of disclosure is not to be interpreted as reflecting an intention that the present disclosure requires more features than are expressly recited in each claim. Rather, as the following claims reflect, the claimed features lie in less than all features of a single foregoing disclosed embodiment, configuration, or aspect.

Advances in science and technology may make equivalents and substitutions possible that are not now contemplated by reason of the imprecision of language; these variations should be covered by the appended claims. This written description uses examples to disclose the method, machine and computer-readable medium, including the best mode, and also to enable any person of ordinary skill in the art to practice these, including making and using any devices or systems and performing any incorporated methods. The patentable scope thereof is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

### EXAMPLES

### Example 1—Standard Single-Length Chain Holder

In one example of the invention, the holder has two sets of holding pegs extending laterally from the sides of the holder, parallel to the cross members at either end of the holder, on the upper and lower members. These holding pegs are in a position such that they and the chainsaw chains are somewhat protected from impacts by the cross members. In this example, additional holes are present in the sides of the upper and lower members, such that the holding pegs can be moved to accommodate at least two different lengths of chainsaw chains.

### Example 2—Multi-Length Chain Holder

In another example of the invention, multiple sets of upper holding pegs are provided, along with one or more lower holding pegs, and holding peg holes for placement of holding pegs such that multiple chains can be held securely by the holder simultaneously. The spacing of the holding peg holes and holding pegs reflects two or more common chainsaw chain lengths, e.g., chains for 16, 18, and 20 inch chainsaw bars. By positioning the holes appropriately for such chain lengths, in this example of the invention, an appropriate amount of tension is achieved, as the biasing mechanism urges the upper member away from the lower member, to hold each chain securely even with multiple chains of differing length. In this example, the holding pegs and holding peg holes are again found on the sides of the holder, in line with the long dimensions of the upper and lower cross members.

### Example 3—Multi-Side Holder with Protective Cross-Plate

In another example of the invention, holding pegs and holding peg holes are provided on all four sides of the central upper and lower members. Pegs and holes are provided as in Examples 1 and 2, but are located on the front and back, as well as the sides, of the holder, allowing additional chains to be placed on pegs and carried or stored safely and securely. In this example of the invention, an upper and lower “end-plate” replaces the cross-member, with the plane of the across plate perpendicular to the upper and lower member and intersecting with the upper and lower members at a central point. This arrangement allows the upper and lower cross-plates to protect all sides of the holder to some extent, just as the standard cross members protect peg placement on the sides of the holder in Examples 1 and 2. The holding pegs and holding peg holes may be arranged on all four sides (the left and right sides, as well as the front and back) in either configuration described for Examples 1 and 2.

What is claimed is:

1. A holder for looped articles, the holder comprising:
a) an upper member,
b) a lower member,
c) at least two holding pegs, and
d) at least one shock absorber or spring,
wherein at least one of the at least two holding pegs is disposed on the upper member and at least one of the at least two holding pegs is disposed on the lower member, and wherein the at least one shock absorber or spring is connected at one end to the upper member and to the lower member at the opposite end, and is configured to urge the upper member and lower member away from one another.

2. The holder of claim 1, wherein the upper member and the lower member are hollow, and the upper member is slidably inserted into the lower member in a coaxial manner.

3. The holder of claim 2, wherein the at least one shock absorber or spring is positioned within the hollow upper and lower members in a coaxial position.

4. The holder of claim 1, further comprising an upper cross member attached to an upper end of the upper member a lower cross member attached to the lower end of the lower member, wherein both cross members are perpendicular to a long axis of the upper and lower members and are attached to the upper and lower members at a point substantially central to a long axis of the upper and lower cross members.

5. The holder of claim 1, further comprising at least two upper holding pegs attached to the upper member and at least two lower holding pegs attached to the lower member.

6. The holder of claim 5, wherein the at least two upper holding pegs are attached to opposite sides of the upper member at the same position relative to a long axis of the upper member, and wherein the at least two lower holding pegs are attached to opposite sides of the lower member at the same position relative to a long axis of the lower member.

7. The holder of claim 4, wherein the holding pegs are attached parallel to the upper and lower cross members.

8. The holder of claim 1, wherein at least one set of two holding pegs are provided by a single peg member that extends through the upper member or extends through the lower member to provide holding pegs on each side of the upper member or lower member.

9. The holder of claim 8, wherein the holding pegs are retained by caps.

10. The holder of claim 9, wherein the caps comprise rubber or polymer.

11. The holder of claim 1, wherein upper member comprises multiple holding peg holes for alternative placement of holding pegs.

12. The holder of claim 1, wherein the lower member comprises multiple holding peg holes for alternative placement of holding pegs.

13. The holder of claim 1, wherein the upper member and lower member comprise holding pegs on four sides of the upper member and lower member.

14. The holder of claim 13, wherein the upper cross member and lower cross member are absent and an upper and lower cross plate are attached to the ends of the upper member and lower member, wherein the plane of each cross plate is perpendicular to the long axis of the upper member and lower member.

15. The holder of claim 1, comprising at least one spring.

16. A holder for looped articles, the holder comprising:
a) an upper member,
b) a lower member,
c) an upper cross member,
d) a lower cross member,
e) at least two holding pegs, and
f) a shock absorber,
wherein at least one of the at least two holding pegs is disposed on the upper member and at least one of the at least two holding pegs is disposed on the lower member, wherein the shock absorber is connected at one end to the upper member and to the lower member at the opposite end, and is configured to urge the upper member and lower member away from one another, and
wherein the upper cross member is connected to the upper end of the upper member and the lower cross member is connected to the lower member, each cross member being substantially perpendicular to the long axis of the upper and lower members.

17. A holder for looped articles, the holder comprising:
a) an upper member,
b) a lower member,
c) at least two holding pegs, and
d) at least one shock absorber or spring,
wherein at least one of the at least two holding pegs is disposed on the upper member and at least one of the at least two holding pegs is disposed on the lower member, wherein the at least one shock absorber or spring is connected at one end to the exterior of the upper member and to the exterior of the lower member at the opposite end, and is configured to urge the upper member and lower member away from one another.

18. The holder of claim 17, comprising at least one shock absorber.

19. The holder of claim 18, comprising at least two shock absorbers.

20. The holder of claim 19, wherein two shock absorbers are connected to the upper member and the lower member on opposite sides of the holder.
